(19) United States
(12) Patent Application Publication
(10) Pub. No.: US 2003/0150200 A1
(43) Pub. Date: Aug. 14, 2003

(54) Lake bottom cleaning device

(76) Inventor: Craig P. Colman, Detroit Lakes, MN (US)

Correspondence Address: Robert E. Kleve, 1103 24th Ave. S., Grand Forks, ND, 58201, US

(21) Appl. No.: 10/327,758

(22) Filed: Dec. 23, 2002

Related U.S. Application Data
(60) Provisional application No. 60/355,969, filed on Feb. 12, 2002.

(51) Int. Cl. A01D 7/00

(52) U.S. Cl. 56/400.1

(57) ABSTRACT

The invention comprises a lake bottom cleaning device. The device has a self supporting base and a elongated boom mounted centrally of its length to the base as a location spaced above the bottom of the base, whereby the base may support the base and boom on the bottom of a lake with the boom spaced parallel above the bottom of the lake. The boom has flexible depending weed engaging means and the boom has a hollow interior with water ports in their outer ends directed in a manner whereby the boom may be connected to a source of water under pressure which water may be delivered into the boom and out the outer ports at the outer ends of the boom with the water propelling out the boom ports providing a jet action to propel the boom to rotate about its rotational mounting to the base with the depending drag means depending onto the lake bottom to engage and drag and clean the lake bottom of weeds on the lake bottom as the boom is rotating by the water propelling action.

This invention relates to cleaning apparatus, more particularly to lake bottom cleaning apparatus. This invention is also related to subject matter of my co pending provisional patent application filed Feb. 12, 2002, Ser. No. 60/355,969 which subject matter is incorporated into this application and the priorty of which is claimed.

It is an object of the invention to provide a novel lake bottom cleaning device which has a rotary boom with a series of the chain loops along the length of the bottom to be dragged by the boom when the apparatus is placed on a lake bottom and the boom is rotated along the lake bottom in path parallel to the lake bottom.

It is a further object of the invention to provide a novel lake bottom cleaning apparatus which has a elongated boom which has a self supporting base to enable the apparatus to be placed self supporting upon a lake bottom with a rotary boom on the base with the boom having a chain portions along the length of the chain which depend onto the bottom of the lake that can be dragged by the boom along the lake bottom when the boom is rotated while placed on the lake bottom.

It is another object of the invention to provide novel self supporting rotary boom which can be rotated while resting on the lake bottom in self supporting relation and has depending drag weed engaging members to drag along the lake bottom upon the boom rotation to clean the lake bottom and rid it of weeds.

Further objects and advantages of the invention will become apparent as the description proceeds and when taken in conjunction with the accompanying drawings, wherein:

### BRIEF DESCRIPTION OF THE DRAWINGS

FIG. 1 is a perspective view of the lake bottom weed removal apparatus.

FIG. 2 is a front elevational view of the weed removal apparatus.

FIG. 3 is an enlarged fragmentary front elevational view of the weed cleaning or removal apparatus.

### BRIEF DESCRIPTION OF PREFERRED EMBODIMENT

Briefly stated, the invention comprises a weed removal apparatus for removing weeds and other vegetation from the bottoms of lake having a center base for resting on the lake bottom, An elongated boom is rotatably mounted on the base which base is sufficiently heavy in weight to thereby self support the base and boom on the bottom of the lake with the base upright on the bottom and the boom parallel to the bottom and spaced above the bottom.

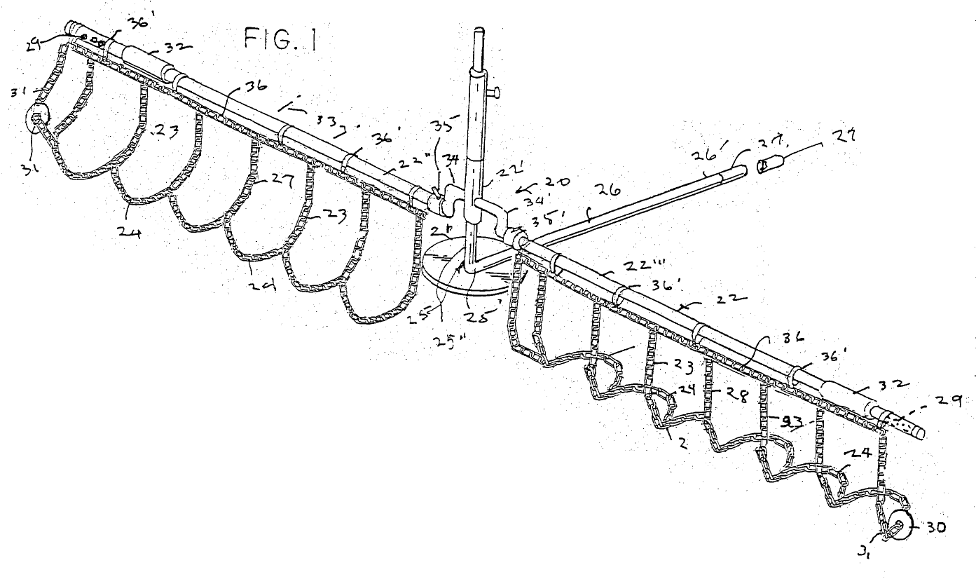

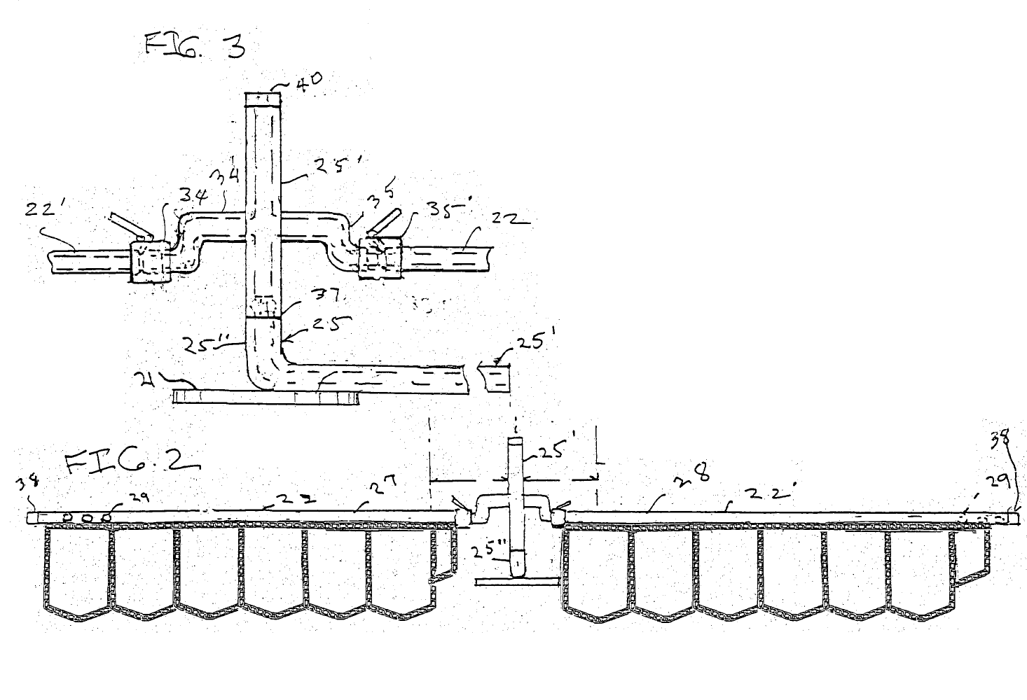

Referring more particularly to the drawings, in FIG. 1, the weed removal apparatus 20 is illustrated having a self supporting base 21 for resting on the bottom of a lake. A elongated hollow boom 22 is rotatably mounted at the middle 22′ of the boom to the base for rotation about an generally vertical axis on the base to extend generally horizontal and parallel to the floor of the lake. The base 21 is made of relatively heavy metal to support the base upright with the boom relatively parallel to the lake bottom and spaced above the lake bottom. The boom has a plurality of spaced elongated flexible chain portions 23 depend downward from the boom to the lake bottom and a looped flexible chain portion 24 is mounted between each pair of depending chain portion 23. Each looped chain portion has its depending chain portion in common with the next adjacent loop chain portion, with only the outer end loop chains having their own depending chain portion 23′.

The looped chain portions 24 depend below the bottom of the base 22 so as to be caused to drag generally horizontal and flush on and along the lake bottom by the depending chain portions and directly engage any weeds on the lake bottom, when the boom is rotated on the support base.

An L shaped elbow tubular conduit 25 is fixed to the base and a relatively rigid pipe 26 is fixed to the horizontal leg 26 of the conduit 25 in fluid communication and a conventional water hose 26″ is connected at one end to the outer end 26′ of the pipe. The hose is sufficiently long that the other end of the hose can be connected to a faucet on the land adjacent the lake to provide water under pressure into the pipe 26 and up in the L shaped conduit 25. From there water travels up into the center pipe 22′ of boom and out opposite pipe branches 33 and 34 and into and along the opposite ends 27 and 28 of the boom 22 toward and the jets or ports 29 at the outer ends of the boom 22. The center pipe 22′ of the boom 22 is rotatably mounted about a vertical axis to the vertical end 25″ of the L shaped outlet 25 of the conduit, so that the water received from the hose into the elbow conduit travels outward from the elbow along the boom to the opposite outer ends of the boom, where the water travels out the ports 29 of the boom to propel rotation of the boom relative to the base, and with the propelling of the boom dragging the chain drag elements 23 and 24 with it, when the apparatus is placed on a lake bottom in an area of the lake an operator wishes to clean weeds and other vegetation from the lake bottom. The depending chain lengths 23 are spaced equally from one another on one side 27 of the booms with the spacing on the other side 28 of the boom equal in distance to the spacing on side 27. However, the chain lengths 23 on the one side 27 of the boom are all spaced offset along the length of the boom from the center L shaped pipe from the chain lengths 23 along the length of the boom on the other side 28 to be between the chain lengths 23 on the other side 28 of the boom when measured out from the center axis of die boom, so that the chain lengths on one side travel in circumferential paths in radial lengths between the radial lengths of the paths of the chains on the other side 28 of the boom, as indicated by the arrows.

This enables the looped chain portions between the chain lengths on the one side to travel on the lake bottom directly below where the chain lengths depend on the other side, this enables a more complete clean the lake bottom of weeds. This is because the ends of the looped chain lengths 24 are held up some times off the lake bottom by the chain depending lengths as the chains are dragged about by the boom in that area of the lake bottom where the looped chain portions connect to the chain length so that the area of the lake bottom directly below each chain length one side of the bottom is not as effectively cleaned by the looped chain portions on the side of the bottom in the area of the bottom directly below each depending chain length.

By having the chain lengths on one side of the boom offset between the chain lengths on the other side of the boom in their circular paths, with respect to their center rotational axis; the area directly below each chain length on one side is effectively cleaned by the looped chain portions on the boom on the other side of the boom, as the boom rotates.

A plurality of ports 29 are provided in the outer ends of each boom on the same side of the boom which the water from the source of water into the conduit can flow from the conduit out the ports in the boom to provide propulsion for rotating the boom in one direction. The ports are located on the side ends of the boom to propel the boom clockwise when viewed from FIG. 1

The base 21 is made of relatively hearty material, such as steel, is self supporting and is of sufficient weight to support the boom, made of relatively light plastic, upright and relatively parallel to the lake floor, as well as support the base vertical, with the boom spaced above the lake floor while rotating, assuming the lake floor is relatively flat.

The device being self supporting may be placed to rest, self supporting, on the lake bottom at different locations on the lake floor to operate clean different locations of the lake bottom. The range of different locations is only primarily limited to the length of the hose 26 between the device and the source of water under pressure.

The device may be operated where the depth of the lake is greater than the height of the boom, so that the boom will be immersed when operated so that the propulsion of fluid from the ports can operate to propel the fluid into the lake water to propel the boom in the lake water. The device may also be operated when the boom is above the surface of the lake, as the water jets from the ports will react in air or in the atmosphere to propel the boom about its center mounting.

A metal disc 30 is mounted to the outside chains 31 of vertical chain segments 23 and 23′ to weight or hold the chain assembly down relative to the boom 22 as the boom 22 is rotated on the base.

At each outer end of the boom is a plastic foam sleeve 32 having formed air pockets therein to make it sufficiently buoyant to float and thereby cause the ends of the boom to flex upward to keep the outer ends upward and high as possible.

The length of chain forming each of the looped portions 24 is greater in length that length of the spacing 33 between each depending chain lengths along the rod 21, so that the looped portions will loop rearward from the rod, as the rod is rotated forward, thereby causing the chain to engage more of the lake bottom for better cleaning of the lake bottom.

The flexible depending chain segments 23 enable the looped chain lengths 24 to adjust to many irregularities in the level of the lake bottom. While the depending drag elements 23 and looped elements 24 are illustrated being formed of chain; other elongated flexible members, such as cable, nylon rope or strips of plastic material, may be used to form the drag elements and loop elements.

The height of the top surfaces of the boom with respect to the bottom of the base is less than a foot so that the device operate in lake bottom areas when the depth of the lake is only a foot or two, assuming that the boom can make continuous repeating 360 degree one directional rotations with the boom entirely under the water of the lake throughout the entire 360 rotation.

The boom is made into two hollow sections 27 and 28 of equal length, and these sections are detachably coupled to the opposite conduit outlets 34 and 34′ of the elbow conduit 25 by the conventional detachable clamping means 35 and 35′. The boom sections including the chains are of approximately the same weight with the substantially the same weight distribution so as to substantially evenly balance the two sections relative to one another so that the boom will more likely remain upright and parallel to the lake floor while rotating on the lake bottom.

The upper ends of the depending chain segments 23 are mounted to a chain 36, which chain 36 is in turn mounted to the boom by straps 36′ spaced along the boom 22. The chain segments 23 could be mounted directly to the boom; however, mounting them to the chain 36 provides a convenient structure for spacing the chain segments 23 along the boom.

The main L elbow conduit 25 has its upper section 25″ rotatably coupled to the center pipe 22′ of the boom at coupling 37. This enables the center pipe 22′ of the boom and the branch outlets and opposite ends of the boom, to rotate relative to the L shaped outlet while the water from the hose travels from the hose up through center pipe and out the branch outlets out along the booms sections and out the ports or jets to propel the boom and center pipe to rotate relative to the L shaped outlet and base.

The booms may as an alternative have a plurality of spaced downward directed ports or outlets along its length, in addition to the propelling horizontal for propelling the boom, which will direct water downward onto the lake floor to engage the weeds and wash them out of their footings in the floor to clean the lake bottom with these downward directed jets as the boom rotates propelled by the horizontal jets. In this instance the depending draw elements and loops of the drag elements may be eliminated. However, the preferred embodiment is using the depending chain (and loop) cheating drag elements previously described.

The booms have removable end caps 38 threaded into the outer ends of the boom, which may be removed and tubular boom extension threaded into the outer ends of the booms to make the boom longer to cover a larger area, with the end caps then threaded into the outer ends of the boom extensions.

Also, the center pipe and base of the device may be used alone, with the boom extensions detached from the center pipe by the quick detachable couplings clamps 35 and 35′ being used to detach the booms extensions 27 and 28 from the center pipe. Then end caps may be coupled to the center pipe outlets 34 and 34′; and the upper end of the center pipe may have a water outlet 40, so that the device may be used alone on the lake bottom, as a fountain, pumping water vertically upward and out the top of the center pipe through the outlet 40, or an aerator may be attached to the top of the center pipe to aerate the water.

Thus, it will be seen that a novel self supporting lake bottom clearing device has been provided for cleaning the bottom of a lake which is self supporting on the lake bottom, so that it can be moved to different areas of the lake bottom and operated or used to clean that area limited only by length of hose supplying water under pressure to the boom.

It will be obvious that various changes and departures may be made to the invention without departing from the spirit and scope thereof; and accordingly, it is not intended that the invention be limited to that specifically described in the specification or as illustrated in the drawings, but only as set forth in the appended claims wherein:

What is claimed:

1. A lake bottom cleaning device comprising a self supporting base; a elongated bottom mountd centrally of its length to the base, said base acting to support the boom on a lake bottom for rotation of the boom on lake bottom, a plurality of chain loop portions along the length of the boom on either side of the base, means to depend the chain loop portions from the boom at a location adjacent and substantially flush with the lake floor, whereby when the boom is rotated on the base, the chain looped portions will engage weeds and other vegetation on the lake bottom to remove the weeds from the lake bottom, a hose for connection at one end to a source of water under pressure and connectable to the boom at its other end, said boom having water outlet ports in their outer ends aligned in direction whereby when water under pressure is introduced to the boom the water will project out the ports in the outer ends of the boom to propel the boom to rotate on the base for the cleaning of the lake bottom.

2. A lake bottom cleaning device comprising a rotary rod, a self supporting base, means on the base to rotatably support the rod about path spaced above the bottom of the base so that the base may be placed to rest at different locations upon a lake bottom and will support the rod so that the rod may rotate on the base while self supporting on the base spaced above the lake bottom, depending flexible means mounted to the rod at spaced intervals along the length of the rod and with lower ends depending downward from the rod to a level substantially adjacent the bottom of the base so as to be adjacent the lake bottom, elongated flexible drag means suspended from the flexible means their lower ends and extending in a plane substantially parallel to the along the rod means so as to contact the lake bottom along the length of the rod so that when the rod rotates on the base the flexible drag means will engage weeds and other vegetation that may be growing on the lake bottom and cause them to be removed from their growing engagement with lake bottom.

3. A lake bottom cleaning device according to claim 2, wherein said elongated flexible drag means comprises flexible elongated chain means running substantially continuously along the length of the rod with said chain means suspended from said lower ends of said depending flexible means at intervals along the length of the rod.

4. A lake bottom cleaning device according to claim 4, wherein said rod is hollow, coupling means on the base adapted to couple the rod in fluid communication with a hose coupling on the base, so that a hose may be coupled to the hose coupling on the base to enable the rod to receive water from the hose when the hose at its other end is connected to source of water under pressure while the base with the rod thereon is placed on the lake bottom with the rod and base immersed in the lake water, said rod having outlets at its outer end so that the water from the hose may travel out the outlets in the outer ends of the rod to propel the rod on the base to cause the rod to rotate on the base.

5. A lake bottom cleaning device comprising a self supporting center base, a center outlet an elongated hollow boom mounted centrally of its length to the center outlet on the center base, said center base, said center base being adapted to be self standing on a lake bottom to support the center base vertically on the lake bottom with the boom extending horizontally parallel to and spaced above the lake bottom, said center outlet being adapted to be connected to a source of water with said boom having water port outlets at opposite outer ends directed horizontally arcuately in the same direction about the center of the boom so that water may be pumped from the source of water into the center base and out the ports at the outer ends of the boom to propell the boom in one directions about the center base, means directed downward from along the length of the bottom for engaging the lake bottom to clean the lake bottom while the boom rotates.
